(19) United States
(12) Patent Application Publication
(10) Pub. No.: US 2011/0063608 A1
(43) Pub. Date: Mar. 17, 2011

(54) Sensing Module for Light-Emitting Devices and Testing Apparatus Using the Same

(75) Inventors: Choon Leong Lou, Hsinchu City (TW); Li Min Wang, Hsinchu City (TW); Yi Ming Lau, Hsinchu City (TW); Ho Yeh Chen, Hsinchu City (TW)

(73) Assignee: STAR TECHNOLOGIES INC., Hsinchu City (TW)

(21) Appl. No.: 12/857,036

(22) Filed: Aug. 16, 2010

Related U.S. Application Data
(60) Provisional application No. 61/242,144, filed on Sep. 14, 2009.

(51) Int. Cl. G01N 21/01

(52) U.S. Cl. 356/244

(57) ABSTRACT

A sensing module for light-emitting devices includes a substrate having at least one first hole and at least one second hole connected to the first hole, an optical device positioned in the first hole and configured to collect emitting lights from the light-emitting device to the first hole, a light-guiding device positioned in the second hole, a reflector positioned in the first hole and configured to reflect the emitting lights from the light-emitting device to the light-guiding device, and an optical coupler positioned at a front end of the substrate and coupled with the light-guiding device.

### BACKGROUND OF THE INVENTION

1. Technical Field

The present disclosure relates to a sensing module for light-emitting devices and testing apparatus using the same, and more particularly, to a testing apparatus with a design for a removable sensing module configured to guide lights emitted from the light-emitting device in the oven to the outside of the oven without affecting the high temperature environment within the testing apparatus.

2. Background

Light emitting diodes (LED) are well known in the art. Testing of LEDs involves measurement of the light intensity emitted by the LED devices at a predefined wavelength spectrum. To ensure accurate comparative testing of the LED devices, the light emitted by the devices must be collected at a precise, reproducible manner, e.g., at a predefined distance or angle, and delivered to a light detector using appropriate optics.

Due to the high volume of required reliability data which is usually collected over a long period of time, these devices are diced and packaged into individual packages and tested in high temperature conditions in a testing apparatus. The next level of quality assurance is to ensure that all infant failures are eliminated through a burn-in test before shipping to customers. The LEDs formed on the wafer are cut so as to separate the dies. Each die is then assembled into a light-emitting package with bond wires connecting the bond pads of the die with the pins of the package. Once the die is assembled in a package it undergoes a burn-in test to ensure the quality and reliability of the light-emitting devices. It is absolutely necessary to conduct the burn-in test, which is a screening test conducted at high temperatures in a testing apparatus in order to eliminate early failures before shipment.

US 2008/0297771 discloses a high-speed optical sensing device including an optical detector, a lens set, and a splitter. The optical detector is utilized for detecting luminous intensity, the lens set is utilized for concentrating light beams toward a color analyzer, and the splitter is aligned to the illuminating device to be tested and is utilized to separate the light beam generated by the illuminating device to the optical detector and the lens set simultaneously.

### SUMMARY

One aspect of the present disclosure provides a testing apparatus with a design for a removable sensing module configured to guide lights emitted from the light-emitting device in the oven to the outside of the oven without affecting the high temperature environment within the testing apparatus.

A sensing module for light-emitting devices according to this aspect of the present disclosure comprises a substrate having at least one first hole and at least one second hole connected to the first hole; an optical device positioned between the first hole and a light-emitting device, the optical device being configured to collect emitting lights from the light-emitting device to the first hole; a light-guiding device positioned in the second hole; a reflector positioned in the first hole and configured to reflect the emitting lights from the light-emitting device to the light-guiding device; and an optical coupler positioned at a front end of the substrate and coupled with the light-guiding device.

A testing apparatus for light-emitting devices according to another aspect of the present disclosure comprises an oven including a front wall having at least one front opening; a carrier module configured to load at least one light-emitting device into the oven through the front opening in a removable manner; and a sensing module configured to guide lights emitted from the light-emitting device in the oven to the outside of the oven. In one embodiment of the present disclosure, the sensing module comprises a substrate having at least one first hole and at least one second hole connected to the first hole; an optical device positioned between the first hole and a light-emitting device, the optical device being configured to collect lights from the light-emitting device to the first hole; a light-guiding device positioned in the second hole; a reflector positioned in the first hole and configured to reflect the lights from the light-emitting device to the light-guiding device; and an optical coupler positioned at a front end of the substrate and coupled with the light-guiding device. In one embodiment of the present disclosure, the sensing module is configured to load the light-guiding device and the reflector into the oven through the front opening in a removable manner so as to form an optical path to guide lights emitted from the light-emitting device in the oven to the outside of the oven.

The removable design of the sensing module allows operators not to place the optical path consisting of the optical lenses and the light-guiding device in the testing environment at high temperature and/or high humidity so as to prevents the optical path from being degraded under the high temperature and/or high humidity in the oven over long stress time. In addition, due to the optical path design, the testing apparatus of the present disclosure allows the operator to guide lights emitted from the light-emitting device in the oven to the outside of the oven without affecting the high temperature environment within the testing apparatus.

The foregoing has outlined rather broadly the features and technical advantages of the present disclosure in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the invention as set forth in the appended claims.

### BRIEF DESCRIPTION OF THE DRAWINGS

The objectives and advantages of the present disclosure are illustrated by the following description and upon reference to the accompanying drawings in which:

FIG. 1 and FIG. 2 illustrate a testing apparatus for light-emitting devices according to one embodiment of the present disclosure;

FIG. 3 illustrates a carrier module according to one embodiment of the present disclosure;

FIG. 4 and FIG. 5 illustrate a sensing module according to one embodiment of the present disclosure;

FIG. 6 illustrates a sensing module according to another embodiment of the present disclosure; and

FIG. 7 illustrates a sensing module according to another embodiment of the present disclosure.

### DETAILED DESCRIPTION

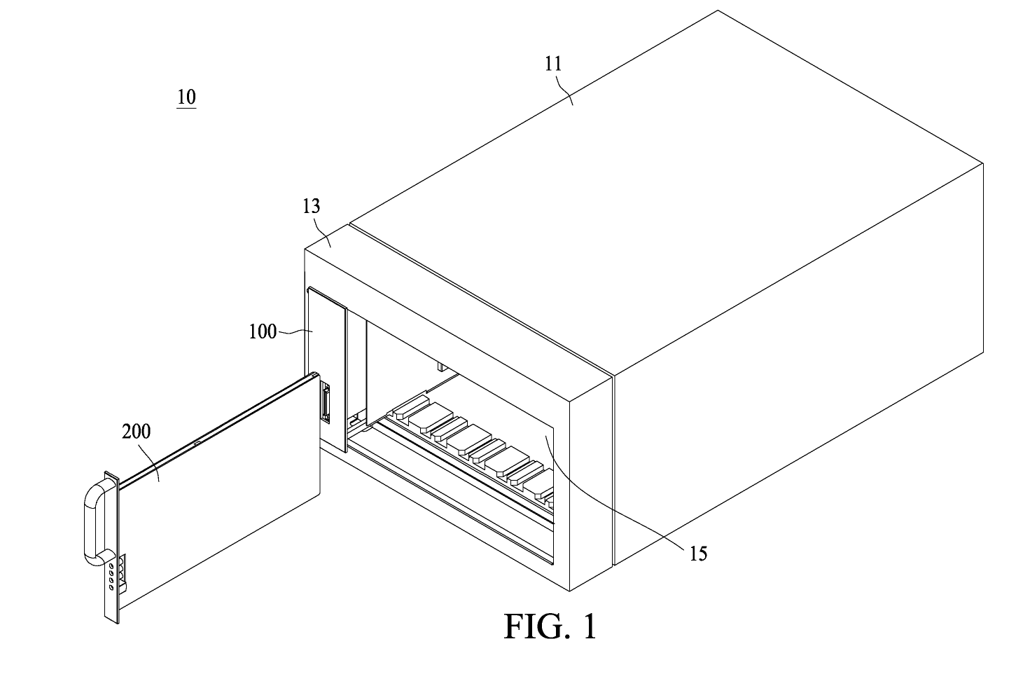

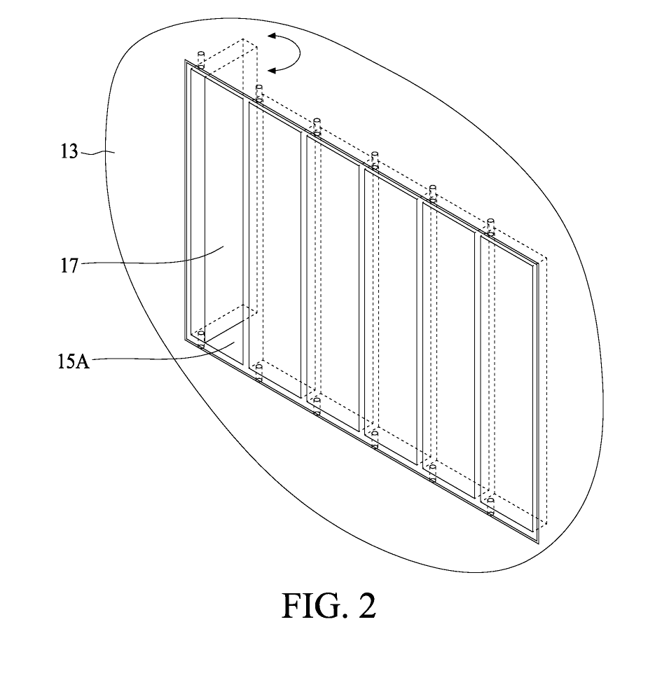

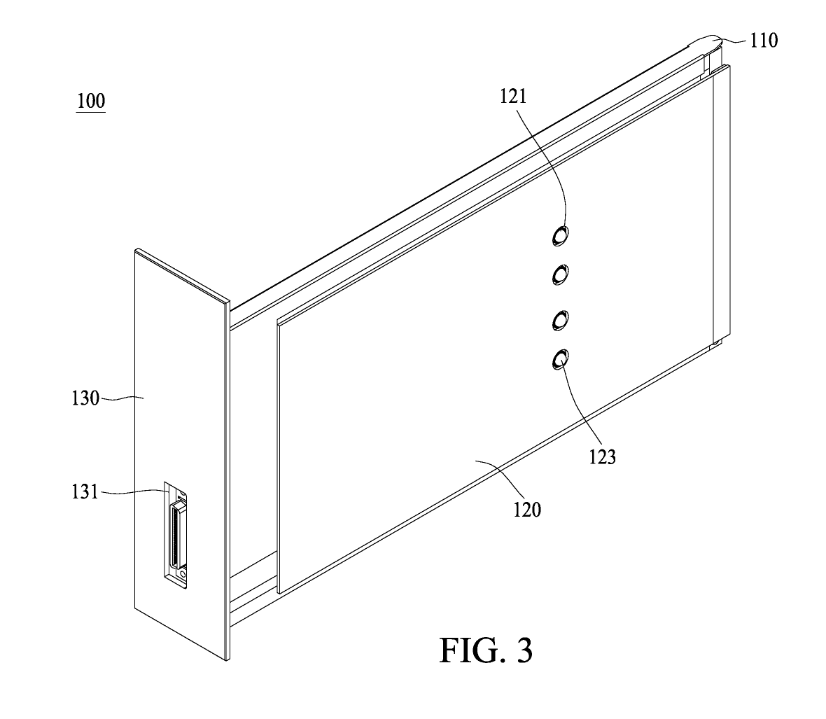

FIG. 1 and FIG. 2 illustrate a testing apparatus 10 for light-emitting devices 123 according to one embodiment of the present disclosure. Referring to FIG. 1, the testing apparatus 10 comprises an oven 11 including a front wall 13 having at least one front opening 15, a carrier module 100 configured to load light-emitting devices 123 (shown in FIG. 3) into the oven 11 through the front opening 15 in a removable manner, and a sensing module 200 configured to guide lights emitted from the light-emitting device 123 inside the oven 11 to the outside of the oven 11.

Referring to FIG. 2, in one embodiment of the present disclosure, the front wall 13 has a plurality of front openings 15A each with a self-closing door 17 to isolate the internal testing environment of the testing apparatus 10 from the surrounding environment. Consequently, the testing apparatus 10 allows the carrier module 100 and the sensing module 200 to be inserted into and removed from the oven 11 through the front openings 15A of the front wall 13; in other words, the testing apparatus 10 of the present disclosure allows the operator to load the optical sensor 240 and the light-emitting device 123 into the testing oven 11 without affecting the high temperature environment within the testing apparatus 10. In one embodiment of the present disclosure, the optical sensor 240 can be the photo detector or the spectrum analyzer.

FIG. 3 illustrates a carrier module 100 according to one embodiment of the present disclosure. In one embodiment of the present disclosure, the carrier module 100 includes a frame 110, a circuit board 120 positioned on one side of the frame 110 and having a plurality of holes 121 with the light-emitting devices 123 under test positioned inside the holes 121, and a front plate 130 with an electrical connector 131. In one embodiment of the present disclosure, the electrical connector 131 is electrically connected to a tester (not shown in the drawings), which controls the testing process, including setting parameters such as the applied current to the light-emitting devices 123 during the testing process.

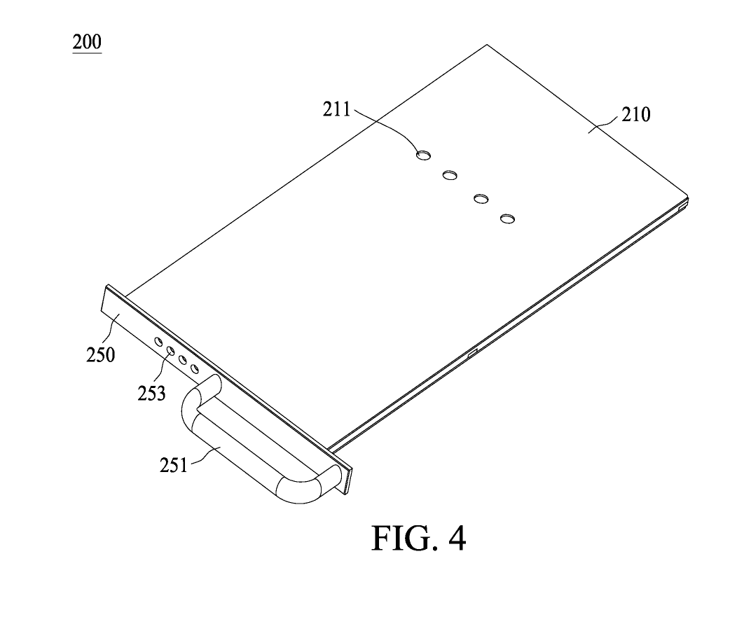

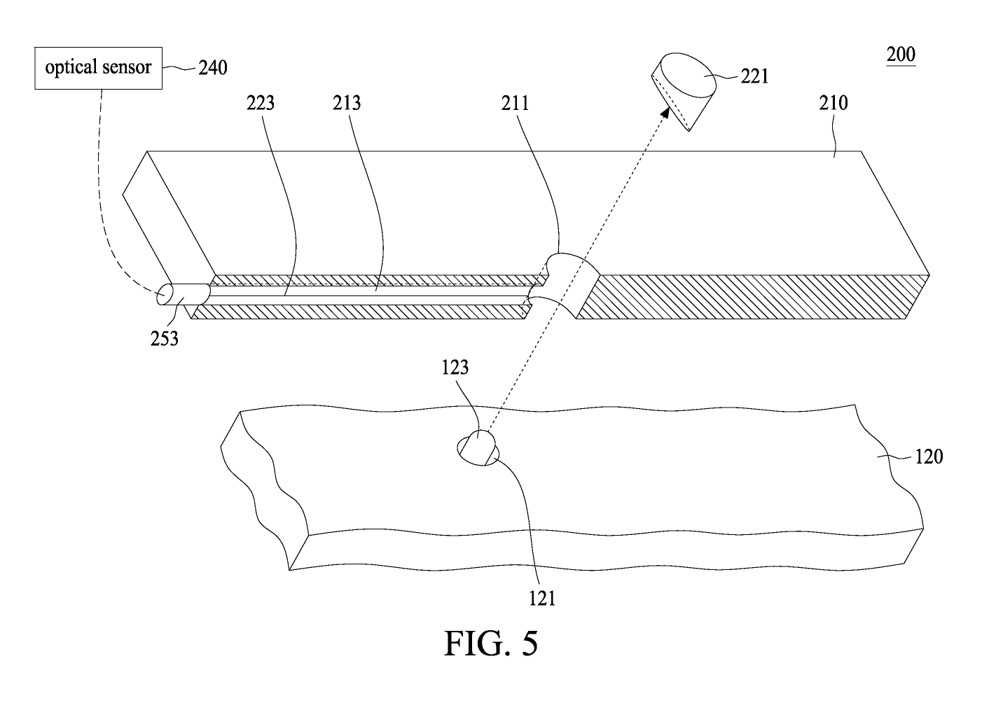

FIG. 4 and FIG. 5 illustrate a sensing module 200 according to one embodiment of the present disclosure. In one embodiment of the present disclosure, the sensing module 200 comprises a substrate 210 having at least one first hole 211 and at least one second hole 213 connected to the first hole 211, a light-guiding device 223 such as the optical fiber or optical waveguide positioned in the second hole 221, a reflector 221 positioned in the first hole 211 and configured to reflect the emitting lights from the light-emitting device 123 to the light-guiding device 223, and an optical coupler 253 positioned at a front end of the substrate 210 and coupled with the light-guiding device 223. In one embodiment of the present disclosure, the sensing module 200 is configured to load the light-guiding device 223 and the reflector 221 into the oven 11 through the front opening 15 in a removable manner so as to form an optical path to guide lights emitted from the light-emitting device 123 in the oven 11 to the outside of the oven 11.

In one embodiment of the present disclosure, the first hole 211 and the second hole 213 are positioned in the substrate 210 in a substantially perpendicular manner. In one embodiment of the present disclosure, the sensing module 200 further comprises a front plate 250 positioned at the front end of the substrate 210, and a grip member 251 positioned on the front plate 250. In one embodiment of the present disclosure, the front plate 250 includes a plurality of optical couplers 253 each coupled with one of the light-guiding devices 223 in the second hole 213.

During the testing of the light-emitting device 123 under test, the sensing module 200 is inserted into the oven 11 through the front opening 15 such that the light-emitting device 123 on the carrier module 100 faces a respective reflector 221 in the first hole 211 on the sensing module 200, and the optical coupler 253 is coupled with the optical sensor 240, which sensing the emitting lights of the light-emitting device 123 under test to determine whether the light-emitting device 123 under test complies with the predetermined specification. Once the sensing is completed, the sensing module 200 is preferably removed from the front opening 15 to the outside of the oven 11, rather than remaining in the testing environment while the sensing is not performed.

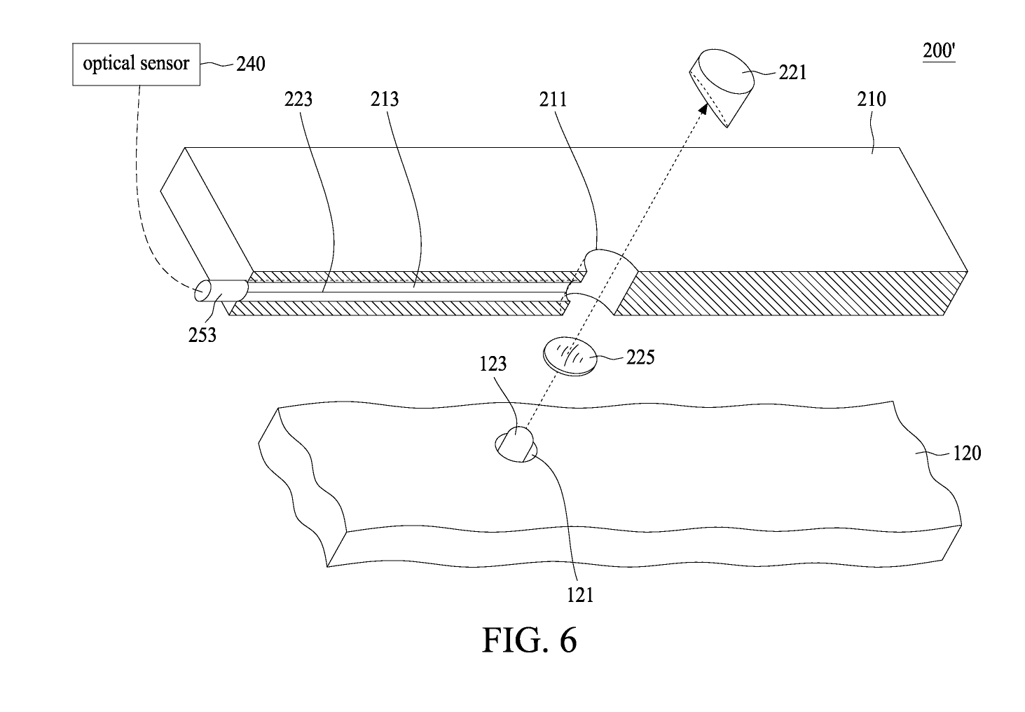

FIG. 6 illustrates a sensing module 200′ according to another embodiment of the present disclosure. In one embodiment of the present disclosure, the sensing module 200′ further comprises an optical device 225 positioned between the first hole 211 and a respective light-emitting device 123 under test, and the optical device 225 is an optical lens such as a condenser configured to collect emitting lights from the light-emitting device 123 to the light-guiding device 223 in the first hole 211.

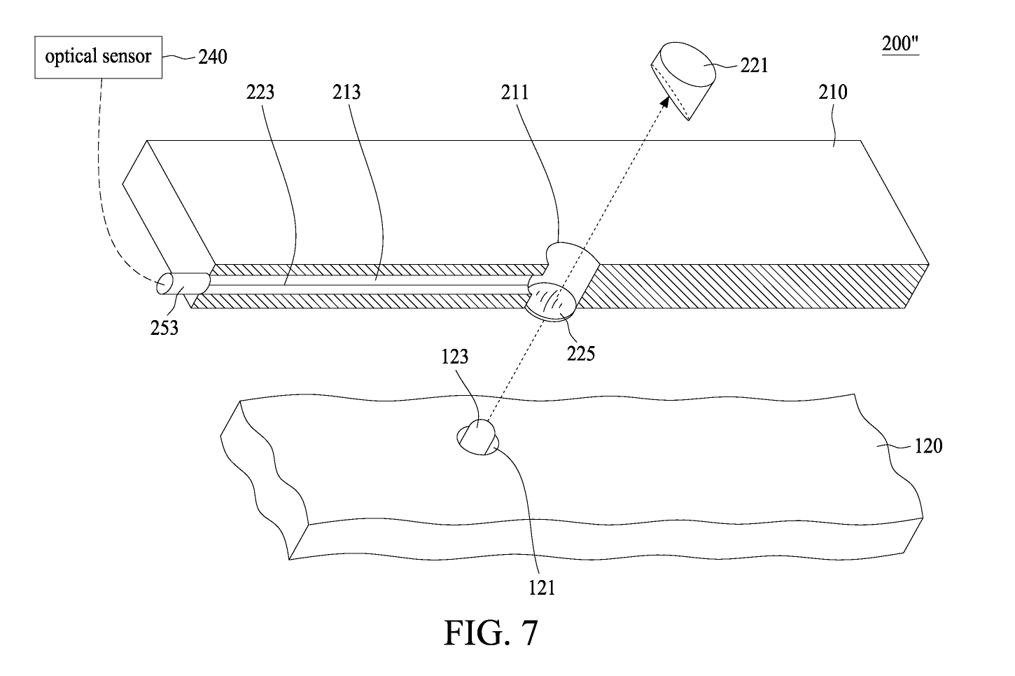

FIG. 7 illustrates a sensing module 200″ according to another embodiment of the present disclosure. In one embodiment of the present disclosure, the sensing module 200″ further comprises an optical device 225 positioned in the first hole 211 and facing a respective light-emitting device 123 under test, and the optical device 225 is an optical lens such as a condenser configured to collect emitting lights from the light-emitting device 123 to the light-guiding device 223 in the first hole 211.

In particular, the removable design of the sensing module allows operators not to place the optical path consisting of the optical lenses and the light-guiding device in the testing environment at high temperature and/or high humidity so as to prevents the optical path from being degraded under the high temperature and/or high humidity in the oven over long stress time. This helps prevent damage to the optical path, and the damage of the light-guiding device obviously affects the accuracy of the optical test data. In addition, due to the optical path design, the testing apparatus of the present disclosure allows the operator to guide lights emitted from the light-emitting device in the oven to the outside of the oven without affecting the high temperature environment within the testing apparatus.

Although the present disclosure and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A sensing module for light-emitting devices, comprising:
a substrate having at least one first hole and at least one second hole connected to the first hole;
a light-guiding device positioned in the second hole;
a reflector configured to reflect the emitting lights from the light-emitting device to the light-guiding device; and
an optical coupler positioned at a front end of the substrate and coupled with the light-guiding device.

2. The sensing module for light-emitting devices of claim 1, wherein the first hole and the second hole are positioned in the substrate in a substantially perpendicular manner.

3. The sensing apparatus for light-emitting devices of claim 1, wherein the light-guiding device is an optical fiber.

4. The sensing apparatus for light-emitting devices of claim 1, wherein the light-guiding device is an optical waveguide.

5. The sensing module for light-emitting devices of claim 1, further comprising a grip member positioned at the front end of the substrate.

6. The sensing module for light-emitting devices of claim 1, further comprising a front plate positioned at the front end of the substrate.

7. The sensing module for light-emitting devices of claim 1, wherein the reflector is positioned in the first hole.

8. The sensing module for light-emitting devices of claim 1, further comprising an optical device configured to collect emitting lights from the light-emitting device to the first hole.

9. The sensing module for light-emitting devices of claim 8, wherein the optical device includes an optical lens.

10. The sensing module for light-emitting devices of claim 8, wherein the optical device is positioned between the first hole and the light-emitting device.

11. The sensing module for light-emitting devices of claim 8, wherein the optical device is positioned in the first hole.

12. A testing apparatus for light-emitting devices, comprising:
an oven including a front wall having at least one front opening;
a carrier module configured to load at least one light-emitting device into the oven through the front opening in a removable manner; and
a sensing module configured to guide lights emitted from the light-emitting device in the oven to the outside of the oven, the sensing module comprising:
a substrate having at least one first hole and at least one second hole connected to the first hole;
a light-guiding device positioned in the second hole;
a reflector configured to reflect the lights from the light-emitting device to the light-guiding device; and
an optical coupler positioned at a front end of the substrate and coupled with the light-guiding device.

13. The testing apparatus for light-emitting devices of claim 12, wherein the first hole and the second hole are positioned in the substrate in a substantially perpendicular manner.

14. The testing apparatus for light-emitting devices of claim 12, wherein the light-guiding device is an optical fiber or an optical waveguide.

15. The testing apparatus for light-emitting devices of claim 12, wherein the sensing module is configured to load the light-guiding device and the reflector into the oven through the front opening in a removable manner.

16. The testing apparatus for light-emitting devices of claim 12, further comprising a grip member positioned at the front end of the substrate.

17. The testing apparatus for light-emitting devices of claim 12, further comprising a front plate positioned at the front end of the substrate.

18. The testing apparatus for light-emitting devices of claim 12, wherein the oven includes a self-closing door for the front opening.

19. The testing apparatus for light-emitting devices of claim 12, wherein the oven includes a plurality of front openings.

20. The testing apparatus for light-emitting devices of claim 12, wherein the reflector is positioned in the first hole.

21. The testing apparatus for light-emitting devices of claim 12, further comprising an optical device configured to collect emitting lights from the light-emitting device to the first hole.

22. The testing apparatus for light-emitting devices of claim 21, wherein the optical device includes an optical lens.

23. The testing apparatus for light-emitting devices of claim 21, wherein the optical device is positioned between the first hole and a light-emitting device under test.

24. The testing apparatus for light-emitting devices of claim 21, wherein the optical device is positioned in the first hole.
